(19) United States
(12) Patent Application Publication
(10) Pub. No.: US 2011/0108000 A1
(43) Pub. Date: May 12, 2011

(54) APPARATUS AND METHOD FOR OPERATING AN ENGINE WITH NON-FUEL FLUID INJECTION

(76) Inventors: Tudor D. Williams, Los Angeles, CA (US); Evan Williams, Los Angeles, CA (US)

(21) Appl. No.: 13/001,113

(22) PCT Filed: Jun. 26, 2009
(86) PCT No.: PCT/US09/48882

§ 371 Date: Dec. 23, 2010

Related U.S. Application Data
(60) Provisional application No. 61/133,176, filed on Jun. 26, 2008.

(51) Int. Cl. F02B 47/02

(52) U.S. Cl. 123/25 C

(57) ABSTRACT

A water injector has a plug end fitting for installation on the individual combustion chambers of an internal combustion engine of the spark ignition or compression ignition type, though which a quantity of water or other non-fuel fluid is injected into the combustion chamber. The temperature and combustion pressure of each combustion chamber as well as the temperature, pressure and humidity of the atmosphere may be monitored and used to control the quantity of water injected into the combustion chambers such that the engine operates at internal combustion conditions equivalent to those occurring at the standard ISO rated atmospheric conditions and thus delivers its ISO rated output regardless of atmospheric conditions. A nozzle is fitted to the plug end of the water injector containing a plurality of openings to inject the water or other non-fuel fluid into the combustion chamber in a predetermined spatial spray pattern. For spark-ignited engines, a high energy pre-chamber may be integrated with the water injector to facilitate ignition when water is injected into the compression cycle. For Diesel engines, the water injection nozzle may be provided with a spatial spray pattern that complements that of the Diesel injector within the cylinder. Engine efficiency may be further enhanced by using an exhaust heat exchanger to preheat at least some of the fluid being injected into the engine and by combining a first injection of fluid at a lower temperature for controlling combustion and otherwise improving efficiency during the compression stroke with a second injection of fluid at a substantially higher temperature during the expansion stroke for maintaining a high rated output during non ISO conditions.

### CLAIM FOR PRIORITY

This application claims benefit of and priority from U.S. provisional application 61/133,176, filed on 28 Jun. 2008.

### FIELD OF THE INVENTION

The invention relates to the structure and mode of operation of internal combustion engines, and more particularly to the injection of a non-fuel fluid such as water into the combustion chamber.

### BACKGROUND OF THE INVENTION

The increased power and gains in fuel economy obtained by the injection of water or other non-fuel fluid into the cylinders of an internal combustion engine have long been known. Water, added during the compression cycle has been shown to reduce the engine NOx.

“ISO conditions” are used when specifying power to account for changes in ambient temperature, pressure and humidity, and are 59° F. (15° C.), atmospheric pressure at sea level (14.54378 psi or 1.01325 bar) and 60% relative humidity, respectively. The predominant mass operating within the cylinder to provide motive power with either the Diesel or Otto cycle is provided by atmospheric air, heated by the fuel added to the engine. Since the density of air is a function of its temperature, pressure, and humidity, the mass within the cylinders and hence the resulting power of the engine can be reduced under certain atmospheric conditions that deviate from the standardized ISO conditions.

Van Dal U.S. Pat. No. 4,589,377 describes the injection of water or other non-fuel material into an Otto cycle internal combustion engine, the amount of non-fuel material being injected and the time of injection being governed by such factors as mass of fuel induced, compression ratio of the engine, quality of the fuel and pre-selected peak temperature of combustion.

Nakayama U.S. Pat. No. 6,112,705 describes the injection of water into a compression ignited (i.e., Diesel cycle) internal combustion engine to lower NOx emission. Zur Loye et al. U.S. Patent Publication No. 2002/0026926 also describe the injection of water into a compression ignited internal combustion engine.

Singh U.S. Pat. Nos. 6,311,651, 6,571,749 and 7,021,272 describe computer controlled internal combustion engines employing the injection of water into each cylinder of the engine, particularly during or after combustion has been initiated in the cylinder. Each cylinder of the internal combustion engine is provided with a pressure sensor and a temperature sensor for measuring the pressure and temperature in the cylinder. These sensors are connected to a computer for controlling the rate and duration of water injected into the cylinder based on the “energy content” of the cylinder determined by signals received from the sensors.

Hobbs U.S. Pat. No. 5,125,366 describes the introduction of water into an internal combustion engine in which a pressurized source of water is utilized. A computer and various engine sensors are employed to control the introduction of water to the cylinders of the engine. Binion U.S. Pat. Nos. 5,718,194 and 5,937,799 describe in-cylinder water injection systems for internal combustion engines. The water is injected at a high pressure, low temperature. Miller U.S. Pat. No. 4,448,153 describes a water injection system for an internal combustion engine that injects water into the cylinders of the engine in response to engine temperature. U.S. Patent Publication No. 2006/0037563, Connor U.S. Pat. No. 5,148,776, and Lee U.S. Pat. No. 6,892,680 all disclose water injection for internal combustion engines in which the injection of water is controlled by a computer in response to one or more sensed engine/cylinder parameters.

The disclosures of the foregoing U.S. Pat. Nos. 4,448,153, 4,589,377, 5,125,366, 5,148,776, 5,718,194, 5,937,799, 6,311,651, 6,571,749, 6,892,680 and 7,021,272, and U.S. Patent Publication Nos. 2002/0026926 and 2006/0037563 are hereby incorporated by reference herein.

### DISCLOSURE OF THE INVENTION

While the benefits and gains in fuel economy by the injection of water (or other non-combustible fluid) into the cylinders of an internal combustion engine have long been known, some or all of the following features are believed to be particularly characteristic of various embodiments of the present invention, both separately and in combination:

(a) a correction in the injected quantity of water (or other non-combustible fluid) injected in response to any change in external air density (pressure and temperature) and/or water content (humidity) in the fuel air mixture;

(b) an ability to adjust the amount of water added to the cylinders in the water injection control system to enable the engine to produce its rated capacity at ISO conditions, independent of current atmospheric conditions;

(c) a high energy ignition system capable of igniting leaner engine mixtures;

(d) an in-cylinder pressure measurement system capable of outputting absolute (ISO) engine pressures;

(e) a pre-chamber design capable of having its flame pattern modified to be compatible with different engine geometrics;

(f) a water injector design capable of having its spray pattern modified to be compatible with different engine geometries and flame patterns of the pre-chamber igniter for Otto cycle engines, or with the Diesel injector spray pattern of a compression ignited engine;

(g) an oil/water separator to remove water from the engine oil;

(h) an exhaust heat exchanger used to preheat the water being injected into the engine to thereby reduce the viscosity of the water used for in-cylinder injection and otherwise promote process efficiency;

(i) a secondary condensing heat exchanger to recover water from the exhaust of the engine;

(j) an organic Rankine variable phase turbine and condenser to extract added energy from the condensing heat exchanger and exhaust; and

(k) supplementing a first injection of water prior to control combustion during the compression stroke with a second injection of water at a higher temperature during the expansion stroke.

Certain embodiments of the present invention provide an internal combustion operating system that enables the engine to operate at internal combustion conditions (such as the pressure and temperature inside the combustion chamber) emulating those occurring at the standard ISO rated atmospheric conditions and thus able to deliver its ISO rated output regardless of atmospheric conditions. A water injector is preferably provided having a plug end fitting to a combustion chamber of an internal combustion engine of the spark ignition or compression ignition type, though which a quantity of water or other non-fuel fluid is injected into the combustion chamber; a nozzle is fitted to the plug end of the water injector containing a plurality of openings to provide the water or other non-fuel fluid to the combustion chamber in a predetermined spatial spray pattern. In those embodiments, the temperature and combustion pressure of each engine chamber as well as the temperature, pressure and humidity of the atmosphere are preferably monitored and used to control the water injected into the combustion chambers. This can not only compensate for lower working fluid mass within the cylinder due to the air's atmospheric characteristics, by the addition of mass from the water injected into the cylinder during the compression and expansion cycles when operating at full rated power under other than standard ISO conditions, but can also improve overall engine efficiency when operating at less than full rated power. In particular, maximum rated power under non-ISO conditions may be achieved when the water is pressurized, preheated, and injected into the cylinder after top dead center whereupon it vaporizes during the expansion stroke.

In accordance with certain characteristic features of other embodiments, water injection may be utilized to increase the engine's power to its rated conditions when atmospheric conditions have reduced the density of air such as to reduce available horse power (de-rate the engine). This can compensate for lower working fluid mass within the cylinder due to the air's atmospheric characteristics, by the addition of mass from the water injected into the cylinder during the compression and expansion cycles. This is believed to be the result of the added mass and therefore the increased pressure inside the combustion chamber. Each engine cylinder's pressure is preferably monitored during each cycle to obtain a gage pressure relative to current actual atmospheric conditions, and the differences in temperature, pressure and humidity between current atmospheric conditions and the ISO rating conditions are then used to convert the measured gage pressure to a corresponding ISO absolute internal pressure at standard ISO rating conditions. By comparing this measured ISO absolute internal pressure with the known absolute internal pressures that are actually produced when operating at maximum rated output at those same ISO rating conditions, water injection can be controlled to return the engine to its rated output regardless of atmospheric conditions.

Water injection into the combustion chamber is preferably controlled by measuring the ambient air's temperature, pressure, and humidity, the water in the fuel, and the water injected in the compression cycle, as well as the engine operational parameters within the combustion chamber such as pressure and temperature, with the sensor for measuring cylinder pressure preferably being integrated with the water injector component. This applies to both Otto cycle (spark-ignited) and Diesel cycle (compression ignited) engines, as well as modifications of these cycles (such as Miller, Split Chamber, and Compressed Charge Ignition engines). The resultant new controlled water injection combustion cycle not only improves engine efficiency (the degree of improvement being affected by the temperature, timing and spray pattern of the injected water) but also permits the production of the maximum rated power measured at ISO conditions under all atmospheric conditions by means of the time controlled, spatially patterned addition of water (or other appropriate non-fuel fluid) directly into the combustion chamber.

Another characteristic feature of certain embodiments of the invention is the introduction of a non-fuel fluid such as water into all cylinder chambers with a unique spray pattern designed for each engine with its unique cylinder and piston geometry, preferably controlling both the spatial pattern of the injected water into the cylinder, as well as the spatial pattern of the fuel's ignition source within the cylinder.

The injectors, igniters, and/or pressure sensors are preferably combined into a single hydrometer device for each cylinder, having a nozzle arrangement at its plug end that intrudes into the combustion chamber and is preferably designed to be secured in place using the standard thread specifications for spark plugs and/or Diesel injectors, or in an alternative embodiment by means of conventional Diesel injector holding clamps. This enables both used and new equipment to be conveniently upgraded in the field to take advantage of many benefits of the various water injection technologies herein described. For spark-ignited engines, a high energy pre-chamber igniter is preferably integrated with the water injector to form a “pyrohydrometer” igniter-injector which independently controls both ignition of the compressed fuel air mixture within the combustion chamber and the injection of water at the appropriate time (or times) during the compression/expansion cycle. For diesel and other compression ignited engines, the water and fuel are preferably independently injected into the combustion chamber by means of a “diesel hydrometer” injector equipped with two sets of nozzle jets, with the water jets having a spatial spray pattern that complements that of the diesel jets.

In accordance with yet another important characteristic of certain other preferred embodiments, a pre-combustion chamber may be incorporated into the water injector design such that a higher energy ignition source exists permitting leaner combustion chamber mixtures (such as would occur with water injection during compression) to be ignited. The pre-combustion chamber can also be used for special fuel addition, such as hydrogen gas, for purposes of better pre-combustion with higher velocity jets going into the combustion chamber, as well as providing lower overall engine emissions with extremely lean fuel mixtures as can occur with large quantities of water injection. The non-fuel fluid can be modified by the addition of peroxide, or urea, or other additives or lubricants to modify the NOx, CO, characteristics of the engine exhaust or the lubricity of the cylinder walls. These additives can also be a function of the measured atmospheric parameters as well as external exhaust measurements.

For diesel engines, liquefied natural gas (LNG) or compressed natural gas (CNG) is preferably substituted for a substantial portion (preferably from about 60% to 98%) of the normal diesel fuel by means of an added fuel input (either CNG or LNG) to the diesel hydrometer, preferably including additional injector outlets in the injector nozzle for the LNG or CNG substitute fuels. Similarly, by injecting a low volatility fuel (such as hydrogen or an oxygen hydrogen mixture (Rhodes' gas or Brown's gas)) that will be ignited only after it has entered the main combustion chamber (preferably by means of additional passageways through the hydrometer), NOₓ can be reduced in the engine exhaust. This is believed to be due to the high velocity flame's ability to ignite extremely lean fuel mixtures as can occur with high quantities of water injection. Addition of these high velocity flame fuels into the combustion chamber is believed to concentrate the ignition closer to top dead center, thus reducing compression pumping losses and further improving engine efficiencies.

An engine controller, with appropriate sensor inputs, is preferably utilized to monitor all of the engine's internal operating parameters, external air temperature, pressure and humidity, water injection temperature, water content in fuel and other fuel parameters. These input parameters are then used by the controller to control the timing of water injection as well as the amount and temperature of water injected into each cylinder with each engine cycle as well as the timing of the ignition system for each cylinder. Especially when combined with an optimal water injection spray pattern inside the combustion chamber, this results in improved engine efficiency when operating at or less than full rated power. Since multiple parameters are input into the controller from different sensor in different cylinders, the water injection/ignition timing controller preferably also evaluates whether each individual sensor is operating properly.

The injection water can have its viscosity modified prior to injection by using the exhaust heat to raise its temperature. A heat exchanger by-pass system permits a full range of water temperatures. This change in viscosity can reduce the water pumping load required for injection, as well as have an effect on the spray pattern within the combustion chamber. The cycle efficiency can also be improved by recovering otherwise wasted heat from the engine exhaust to preheat the water before it is injected into the cylinder.

For turbo-charged Otto cycle engines, water injection can be applied by either (a) misting after the turbo charger, (b) misting prior to each cylinder intake, or (c) direct injection into the combustion chamber during the intake or compression stroke or any combination of the above. The water injection can be used to further increase engine efficiency by removing the heat of compression of the turbo charger (instead of using an inner cooler) as well as to control engine knock (engine pre-ignition or detonation). The efficiency of the Otto cycle can be improved by increasing the pressure ratio and avoiding engine knock by cooling the engine air with water injection to below a temperature inducing engine knock. An engine knock sensor is preferably added to ensure that engine knock will not occur due to cylinder temperature rise prior to ignition.

A water/oil separator is preferably included in the water injection system to remove the water from the engine oil. During engine operation, the engine's combusted gasses mix with the engine oil due to gaps in the piston rings and piston ring clearance, creating the potential for water to be mixed with the engine oil.

In accordance with another important characteristic of certain preferred embodiments, the engine exhaust can be further used to produce energy and recover a major portion of the injected water by installing a condensing heat exchanger and/or a turbo generator. The heat exchanger can either be made from acid-resistant metals or Teflon-coated metal to resist attack from the slightly acidic exhaust gases. An organic Rankine turbine employing a variable phase turbine or trilateral cycle with R245fa (1,1,1,3,3-pentafluoropropane) and condenser can be used to extract energy from the condensing heat exchanger and condense water for injector reuse. Atmospheric air can be blended into the engine exhaust gas to provide the proper temperature conditions for the organic turbine's working fluid within the heat exchanger.

This invention finds utility in a wide range of technical applications, including transportation and power generation, and will typically result in an increase in power and efficiency over what has heretofore been feasible. For use on locomotives and ships, a turbo generator responsive to the exhaust gasses may provide additional power; the required injection water can be transported by the locomotive or can be produced aboard ship by reverse osmosis. For landfill gas (LFG) and other biofuels having a high water content, the water in the fuel performs a similar mass enhancing function as the water being directly injected into the combustion chamber, so rather than being a contaminant that should be filtered out, it is simply measured and provided as an input to the water injection controller.

For a more complete understanding of the present invention, reference is now made to the following detailed descriptions of a few representative presently preferred embodiments and to the accompanying drawings.

### BRIEF DESCRIPTION OF THE DRAWINGS

FIG. 1 is a schematic depiction of a 16 cylinder engine incorporating water injection in accordance with this invention;

FIG. 2 is a schematic depiction of a spark ignited igniter-injector (“pyrohydrometer”) device for use in a spark ignition engine in accordance with an embodiment of this invention;

FIG. 3 is a schematic depiction of a Diesel ignited (micro pilot) pyrohydrometer device for use in a spark ignition engine in accordance with another embodiment of this invention;

FIG. 4 is a schematic depiction of an pyrohydrometer for use in a spark ignition engine that also contains an injector for hydrogen or Brown's gas in accordance with another embodiment of this invention;

FIG. 5 is an enlarged view of the plug end of the pyrohydrometer of FIG. 2 including the igniter-injector nozzle;

FIG. 6 depicts a first arrangement of jet holes for the igniter-injector nozzle of FIG. 2;

FIG. 7 depicts an alternative arrangement of jet holes for the igniter-injector nozzle of FIG. 2;

FIG. 8 is a schematic depiction of a 16 cylinder engine as shown in FIG. 1, but modified for use with liquefied natural gas (LNG);

FIG. 9 is a schematic depiction of a 16 cylinder engine as shown in FIG. 8, but modified for use with compressed natural gas (CNG);

FIG. 10 is a diesel injector with water injection (“diesel hydrometer”); and

FIG. 11 is a diesel hydrometer with CNG or LNG injection; and

FIG. 12 shows a thermodynamic model for evaluating different embodiments.

### DETAILED DESCRIPTION OF PREFERRED EMBODIMENTS

For ease of reading, the following description will generally refer to the use of water as the non-fuel fluid, but it will be understood that other non-fuel fluids can be used. Thus, while water is an obvious choice as the non-fuel fluid to be injected into the combustion chamber as the added mass, other suitable fluids can be used, including inert gases such as argon, nitrogen, carbon dioxide, and ammonia, as well as oxygenated water combinations.

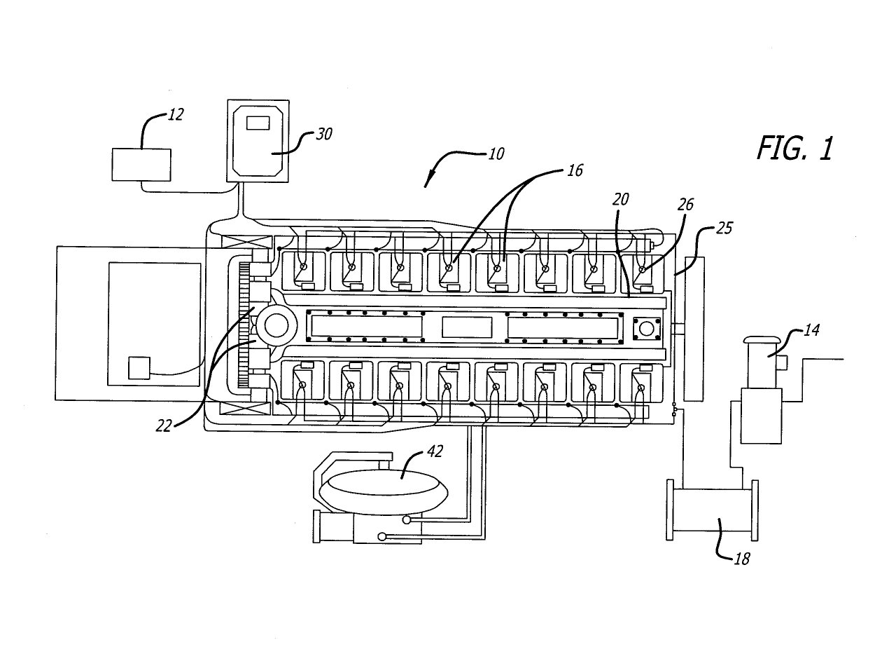

Referring to FIG. 1, a sixteen cylinder engine 10 is provided with the present improvements. An air sensor 12 provides temperature, pressure, and relative humidity of the ambient air. From this atmospheric data and from the current mass flow rate of the incoming engine air, the air density entering the engine and the air mass within any given engine design configuration can be determined.

Processed water (with or without additives) is supplied to a high pressure regulated pump 14. The pump provides high pressure water to each cylinder 16 of the engine 10. The water first passes through an exhaust heat exchanger 18 which raises the temperature of the water. The water is used in both the engine's compression cycle to prevent knock, as well as the engine's expansion cycle to provide added power and improve cycle efficiency. During the initial compression cycle, the water can be either (a) directly injected into the cylinder, or (b) injected into the compressor exhaust of the turbo charger, or (c) injected into the intake valve, or (d) any combination of the above.

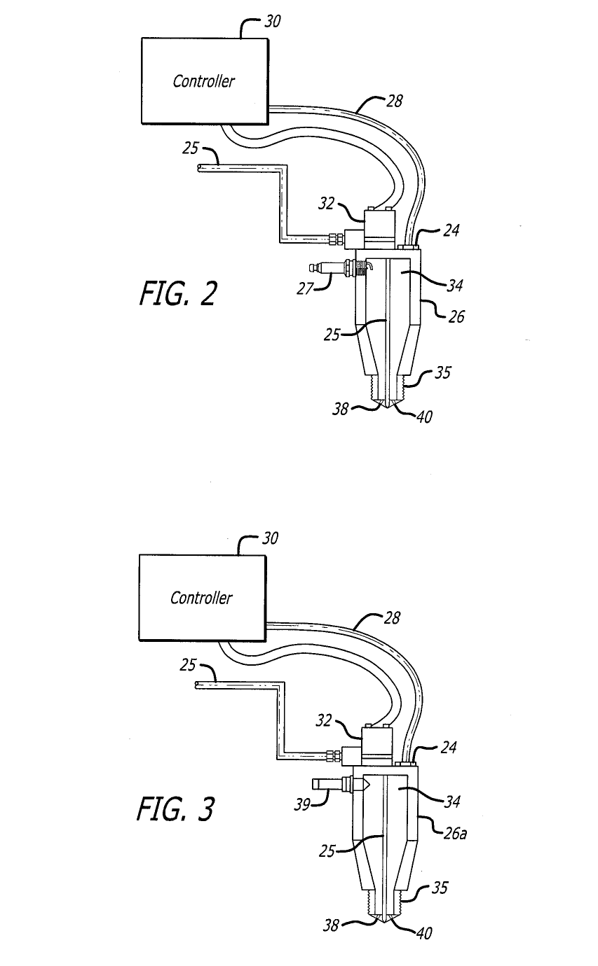

Each cylinder 16 is instrumented with a knock sensor 20, a temperature sensor 22, and a pressure sensor 24 (shown in FIG. 2). The pressure sensors are calibrated to read pressure based upon ISO conditions rather than gage pressure. The corrected ISO data is calculated by using pressure, temperature and humidity inputs from the air sensor 12 (and/or equivalent data derived from a mass flow sensor in incoming air stream) and also takes into account the additional mass attributable to any water or water additives contained in the fuel.

Referring additionally to FIGS. 2, 3 and 4, for a spark ignition engine each cylinder 16 is fitted with an igniter-injector control device capable of fitting within the engine's conventional spark plug screw pattern The igniter-injector control device is preferably in the form of a pyrohydrometer 26 that controls the ignition pattern and timing within each cylinder 16, the water spray pattern, and its timing within each cylinder 16, and by means of the combustion pressure sensor 24 monitors the pressure within each cycle. Water is provided from a high pressure water supply to a water line 25. Each pyrohydrometer contains a pressure sensor 24 to make sure that the manufacturer's ISO rating conditions are not exceeded. The combustion pressure sensor 24 connects over an electrical line 28 to a master controller 30. The pressure sensor output is transmitted as (or is converted to by controller 30) an absolute ISO pressure rather than a relative gage pressure. Water quantity and timing are controlled by the master controller 30 via a water control solenoid 32 to match the ISO rating of the engine, regardless of atmospheric air conditions, by relating the measured parameters to ISO conditions.

Oil-purification system 42 is designed to remove any entrapped water in the oil system. The oil is then returned to the crankcase for engine lubrication.

As shown in FIG. 2, for a spark ignited engine, the pyrohydrometer 26 design contains a spark plug 27 inserted into a pre-combustion chamber 34 which directs high energy flames 36 (see also FIG. 5) of combusted gases from the pre-chamber 34 into the combustion chamber via combustion gas passageways 38. The introduction of high-energy flames 36 t into the combustion chamber (not shown) to permit combustion of leaner (and therefore more fuel efficient) mixtures than would otherwise be possible. The pre-combustion chamber 34 terminates at its plug end in a threaded injector nozzle 35 provided with the passageways 38 extending into pre-combustion chamber 34 and with water jets 40 in sealed fluid communication with water line 25 to provide a water spray pattern that can be customized to match each piston and head geometry, as well as be compatible with the igniter-jet pattern. For example, as best seen in FIG. 5, the individual holes in the threaded nozzle 35 defining water injection jets 40 can be circumferentially slant drilled at an oblique angle to give the water a swirl to thereby promote better mixing with the incoming combustion gases. The proper injection angles for a given engine configuration can be readily determined experimentally by sequentially installing different test nozzles each with a different series of angled drill holes, and selecting the nozzle drill holes providing the best performance.

As shown in FIG. 3, the pyrohydrometer design 26a for a micro pilot ignition engine using Diesel fuel is similar to that shown in FIG. 2, but in which a diesel injector 39 is inserted into the pre-combustion chamber 34. The plug end 35 of the pyrohydrometer 26a is fitted with the engine's ignition device screw pattern (or other appropriate connector).

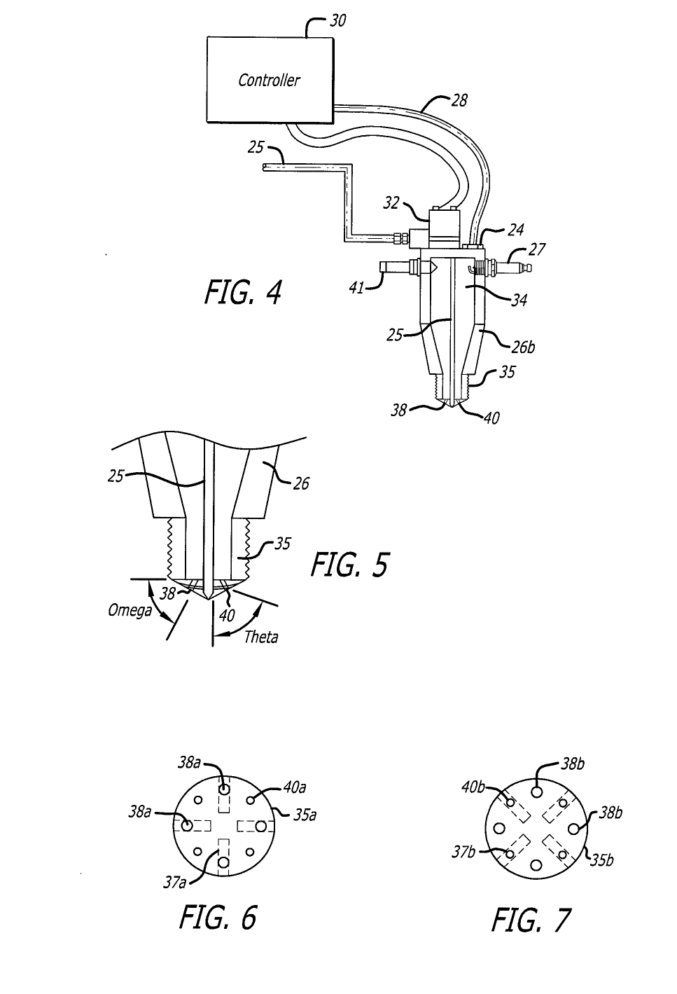

Referring to FIG. 4 a pyrohydrometer 26 is provided for use in a spark ignition engine that is similar to that of FIG. 2, but which also contains an injector 41 for hydrogen or Brown's gas (a stable stoichiometric “mixture” of di-atomic and mon-atomic hydrogen and oxygen). The Browns gas can be in addition to or a substitute for the gaseous fuel entering the pre-chamber 24 via passageways 38. When Browns gas is fed into the pyrohydrometer 26b as illustrated, then the energy of the flame 36 entering the combustion chamber should have very high energy, thereby enabling lower calorific mixtures to be combusted.

Referring to FIG. 6 and FIG. 7, two different pyrohydrometer nozzle designs 35a and 35b have respective internal connecting regions 37a, 37b that can produce two different sets of water spray test patterns. In pattern 35a shown in FIG. 6, the larger gaseous fuel passageways s 38a can be drilled at various points and orientations within region 37a, with the smaller water jets 40a fixed, while in alternate pattern 35b, fuel passageways 38b are fixed and jets 40b can be drilled within region 37b.

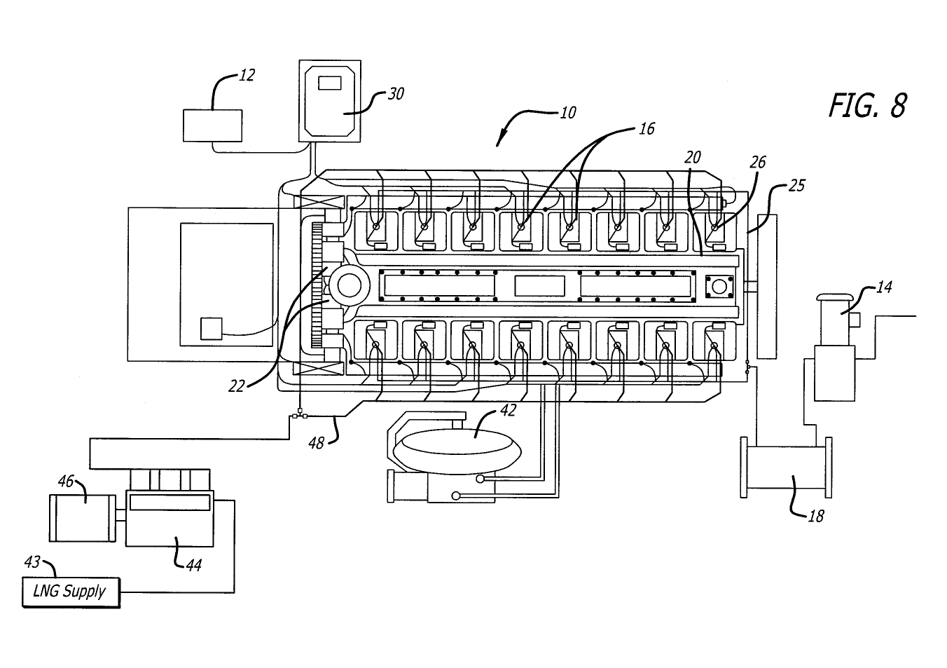

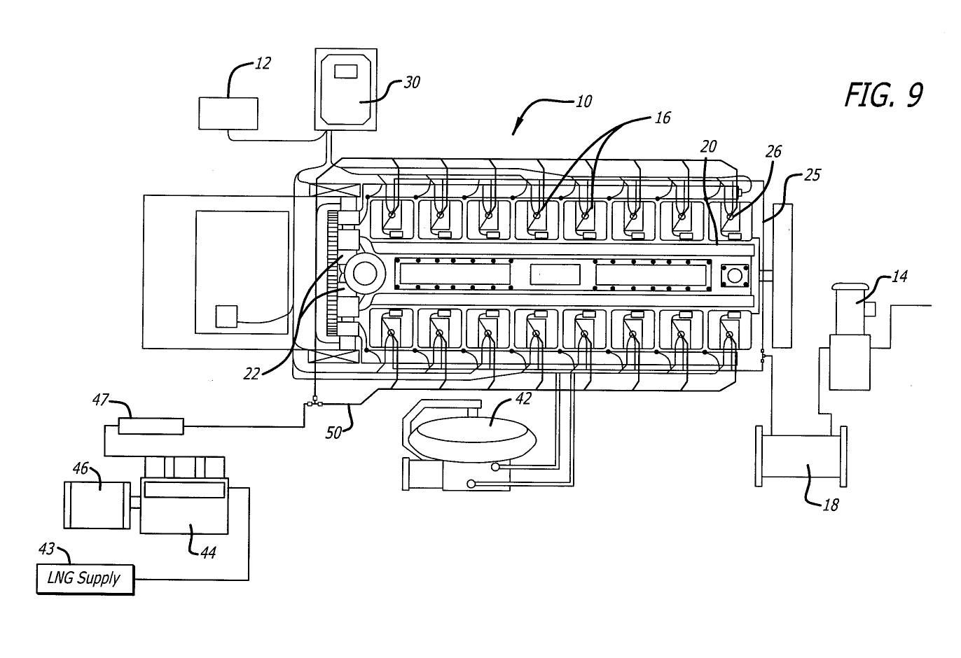

Referring to FIG. 8, a 16 cylinder engine 10a similar to that shown in FIG. 1 has been modified for use with liquefied natural gas fed from a supply 42 of LNG to an LNG pump 44 and drive 46, through an LNG fuel line 48 to the cylinders of the engine.

Referring to FIG. 9, the 16 cylinder engine 10b of FIG. 8 has been further modified for use with compressed natural gas (CNG) fed from a supply 43 of LNG to an LNG pump 44 and drive 46, through a vaporizer 47, then through a CNG fuel line 50 to the cylinders of the engine. In an alternative embodiment (not shown) the CNG could be generated off site and stored and transported in pressurized tanks, in which case It could then be fed directly at point 47 from a control valve.

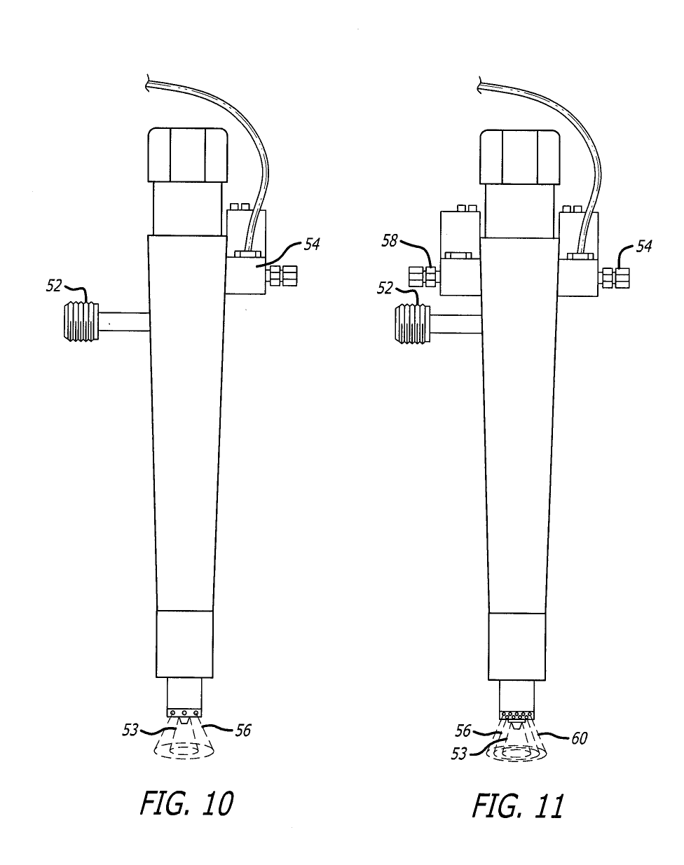

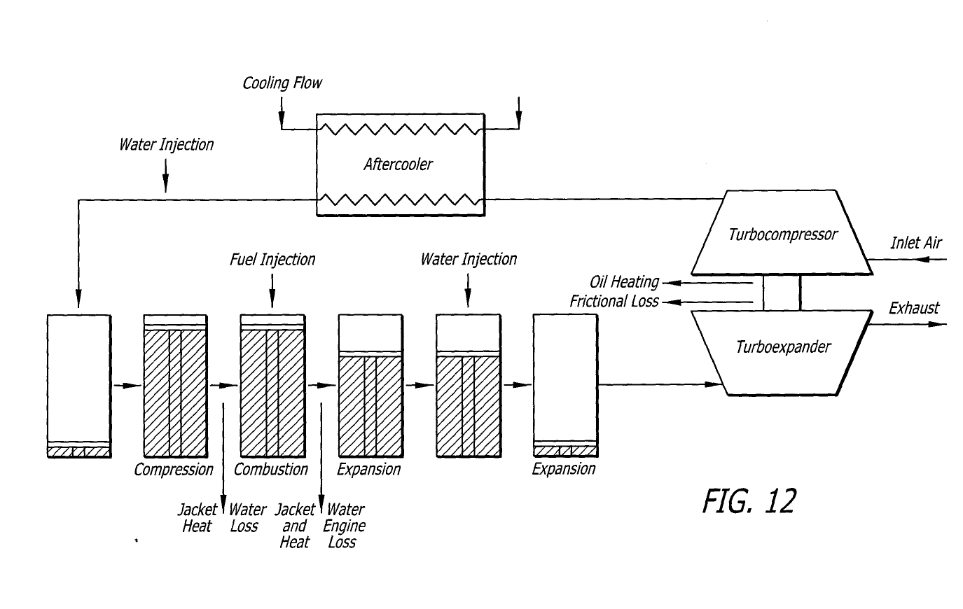

FIG. 10 illustrates a diesel hydrometer for a diesel engine. Its purpose is to take the place of the diesel injector in a diesel engine and contains a diesel inlet 52 and water inlet 54. The injector in FIG. 10 in addition to providing diesel fuel to the engine in a conventional diesel spray cone 53 also introduces water in a concentric spray pattern 56 surrounding Diesel spray cone 53, so that the injected water surrounds the injected diesel fuel. The amount of water is controlled by the controller to bring the engine performance to ISO conditions as well as to displace the amount of diesel fuel used.

The diesel hydrometer in FIG. 11 is similar to that in FIG. 10, but can additionally utilize either CNG or LNG from third inlet 58 as a substitute fuel for some or all of the heavier diesel fuel. In addition to the concentric diesel and water spray cones 53 and 56, it also provides an outer concentric spray cone 60 formed by a corresponding ring of CNG or an LNG jets to introduce the alternative fuel into the combustion chamber. Thus, FIG. 11 has 3 spray patterns whereas FIG. 10 has 2 spray patterns. In both cases, the jets can be relocated to form an optimal set of spray patterns for a particular combustion chamber geometry, similar to the pyrohydrometer nozzle designs shown in FIGS. 6 and 7.

Tables 1 through 4 show numerical results obtained from a computerized thermodynamic model of a typical reciprocating engine (in this case, a CAT G3516C) modified and operated in accordance with various embodiments of the present invention, after calibration with its data sheet efficiency ratings both at maximum power at standard ISO 3046/1 conditions and as derated at non-ISO conditions generator efficiency of 96.7% was assumed and constant turbocharger compressor and expander efficiencies were assumed. Also, the combustion inlet air flow rate along with the cylinder geometry and compression ratio was used to calculate the required turbocharger pressure ratio at ISO (due to lack of a compressor map, the turbocharger pressure ratio was kept constant in the model). The constructed model was mapped through altitude (0 to 12,000 ft), temperature (50 to 130° F.), and humidity (0% to 100%). The off-design performance was determined and tabulated. Using the datasheet, the thermodynamic model was calibrated (for efficiencies of the turbocharger, compression, and expansion).

The Table 1 data was then generated by adding water injection to the model at top-dead center and then matching the resultant calculated flame temperature to that of the ISO reference model without any water injection (this was achieved by varying the fuel flow rate). The amount of water determined the power increase that could be achieved and this process was iterated until the power and flame temperature were brought up to ISO conditions. In particular, it will be seen from Table 1 that the amount of injection water required to maintain full rated output increases at higher altitudes (lower pressures), experiencing a noticeable peak at about 100° F. (38° C.). Table 1 assumes a 60% relative humidity, the same procedure can be repeated for other ambient humidities, so that the required injection water flow rate for a given ambient atmospheric temperature and pressure can be adjusted to take into account the actual humidity, and also to take into account any water already present in the fuel.

A more refined version of that thermodynamic model with more variables (Table 2) was then enhanced (Table 3) to include the benefits of other embodiments of the invention. In particular, varying quantities of water were injected at two different times at two different temperatures during the compression/decompression cycle, not only to increase power, but also to increase efficiency. By injecting a small amount of water at a relatively low temperature (100° F.) before the fuel ignition it was possible to increase the compression ratio from 11.3 to 14 without auto-ignition because the temperature inside the combustion chamber is thereby reduced. In addition to the increased power and efficiency resulting from the increased compression ratio, the water injection is also beneficial in reducing losses two-fold. By reducing the peak temperature, dissociation is reduced, improving combustion efficiency, and losses due to jacket water and heat radiation are also lowered. It was found that the optimum injection point for such efficiency improvements is before the compression, with no water injection during the stroke. This can be accomplished with standard inlet fogging after the aftercooler.

Further calculations using other modifications to the model also suggested that the optimal time for injecting water to enhance power was not at top dead center (as was assumed for Table 1), since that apparently resulted in the water being vaporized when mixed with the combustion gases, thereby quenching the expansion that would otherwise have occurred and producing an immediate drop in the pressure and temperature inside the compression chamber and a resultant reduction in expansion performance. However, if the power enhancing water injection occurs later, preferably once the gases have expanded by a factor of four, then any quenching effect is outweighed by the improvements to both efficiency and power attributable to reduced heat losses in the engine as well as the expansion of the water. Additionally, if the pressurized water for the later occurring injection during the expansion stage is first preheated to a substantially higher temperature (preferably to about 650° F.) using the engine exhaust and the high temperature water is then squirted onto the piston head and walls to both cool the metal surfaces and vaporize, there is a further increase in overall efficiency, as reflected in Table 3 (ISO conditions) and in Table 4 (reduced atmospheric pressure and elevated temperature).

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the appended claims.

TABLE 2

| | Standard | | | | |
|---|---|---|---|---|---|
| | Temp. | Pressure | Flow | | Power |
| | ° F. | psia | lb/stroke | lb/hour | kW |
| Turbocharger Exit | 412 | 36.5 | 0.026707 | 23075 | −555 |
| Water Injection | — | — | — | — | — |
| Piston Inlet | 130 | 36.4 | 0.026707 | 23075 | −502 |
| Compressed | 990 | 1105 | 0.029384 | 25388 | −1691 |
| Fuel Injection | 60 | 1200 | 0.000862 | 745.1 | — |
| Combusted | 2876 | 2634 | 0.030246 | 26133 | — |
| Water Injection | — | — | — | — | — |
| Expanded | 1350 | 103.1 | 0.030246 | 26133 | 3932 |
| TurboCharger Exit | 931 | 15.2 | 0.027570 | 23820 | 555 |
| Engine Net Power | — | — | — | — | 1682 |

TABLE 1

| | | Altitude (ft) | | | | | | |
|---|---|---|---|---|---|---|---|---|
| | | 0 | 2000 | 4000 | 6000 | 8000 | 10000 | 12000 |
| Ambient | 130 | 0.00 | 0.69 | 1.47 | 2.20 | 2.90 | 3.56 | 4.17 |
| Temper- | 110 | 0.00 | 0.73 | 1.51 | 2.25 | 2.95 | 3.61 | 4.22 |
| ature | 90 | 0.00 | 0.72 | 1.50 | 2.24 | 2.95 | 3.62 | 4.23 |
| (° F.) | 70 | 0.00 | 0.67 | 1.46 | 2.21 | 2.92 | 3.59 | 4.21 |
| | 50 | 0.00 | 0.60 | 1.40 | 2.15 | 2.87 | 3.54 | 4.17 |

TABLE 3

| | Increased Compression with Water Inj. | | | | |
|---|---|---|---|---|---|
| | Temp. | Pressure | Flow | | Power |
| | ° F. | psia | lb/stroke | lb/hour | kW |
| Turbocharger Exit | 385 | 34.1 | 0.026707 | 23075 | −522 |
| Water Injection | 100 | 1000 | 0.000162 | 140.0 | — |
| Piston Inlet | 104 | 34.0 | 0.026869 | 23215 | −514 |
| Compressed | 1007 | 1400 | 0.029098 | 25140 | −1788 |
| Fuel Injection | 60 | 1200 | 0.000802 | 693.2 | — |
| Combusted | 2796 | 3221 | 0.029900 | 25834 | — |
| Water Injection | 650 | 2500 | 0.0013 | 1123 | — |
| Expanded | 1125 | 103.7 | 0.031200 | 26957 | 4041 |
| TurboCharger Exit | 909 | 15.2 | 0.028971 | 25031 | 522 |
| Engine Net Power | — | — | — | — | 1682 |

TABLE 4

| | 12.7 psia (4000 ft), 90° F. Ambient with Water Inj. | | | | |
|---|---|---|---|---|---|
| | Temp. | Pressure | Flow | | Power |
| | ° F. | psia | Lb/stroke | lb/hour | kW |
| Turbocharger Exit | 435 | 32.2 | 0.025105 | 21691 | −540 |
| Water Injection | 100 | 1000 | 0.000162 | 140.0 | — |
| Piston Inlet | 103 | 32.1 | 0.025267 | 21830 | −514 |
| Compressed | 1009 | 1309 | 0.027372 | 23650 | −1691 |
| Fuel Injection | 60 | 1200 | 0.000806 | 696.8 | — |
| Combusted | 2890 | 3099 | 0.028179 | 24347 | — |
| Water Injection | 650 | 2500 | 0.0013 | 1123 | — |
| Expanded | 1180 | 101.2 | 0.029479 | 25470 | 3926 |
| TurboCharger Exit | 947 | 13.4 | 0.028971 | 23650 | 540 |
| Engine Net Power | — | — | — | — | 1682 |

1. A method for enhancing the power and efficiency of an internal combustion engine having a known rated capacity at ISO conditions, in which water or other non-combustible fluid is injected into the engine's cylinders during a compression/expansion cycle including a compression stroke and an expansion stroke, comprising the following steps:
monitoring any changes in current atmospheric conditions;
determining an amount of the injected non-combustible fluid required to enable the engine to produce a rated capacity at ISO conditions at the current atmospheric conditions;
correcting a quantity of the injected non-combustible fluid in response to any change in water content of a fuel source.
using an exhaust heat exchanger to preheat at least some of the non-combustible fluid being injected into the engine; and
supplementing a first injection of the non-combustible fluid to control combustion during the compression stroke with a second injection of the preheated non-combustible fluid at a higher temperature during the expansion stroke.

2. The method of claim 1 further comprising one or more of the following additional steps:
providing a hydrometer incorporating a high energy ignition system capable of igniting leaner engine mixtures;
using a secondary condensing heat exchanger to recover water from exhaust of the engine and obtaining absolute (ISO) internal pressures;
modifying a flame pattern output from a pyrohydrometer designed for one specific combustion chamber geometry to be compatible with a different engine combustion chamber geometry;
modifying a spray pattern output from a hydrometer designed for one specific engine design to be compatible with a different engine design; and
providing an oil/water separator to remove water from the engine oil;

3. The method of claim 1 wherein the engine is an Otto cycle engine having a combustion chamber with a specific geometry and a pyrohydrometer outputting a specific flame pattern customized for that geometry.

4. The method of claim 1 wherein the engine is a Diesel cycle engine having a combustion chamber with a specific geometry and a diesel hydrometer outputting a complementary spray patterns of water and fuel customized for that geometry.

5. An internal combustion engine operated in accordance with the method of claim 1, having an injector with a nozzle arrangement extending into a combustion chamber though which at least some of said water or other non-fuel fluid is injected into the combustion chamber, said injector comprising:
plug end means for fitting the injector to the combustion chamber; and
jet means for directing the non-fuel fluid into the combustion chamber in a predetermined spatial spray pattern.

6. The internal combustion engine of claim 5, further comprising an ignition pre-chamber integrated with the injector for providing a predefined flame pattern into the combustion chamber.

7. The internal combustion engine of claim 5, further comprising a second set of jets for injecting a diesel fuel into the combustion chamber with a predetermined spray pattern complementing a corresponding spray pattern of the jet means.

8. The internal combustion engine of claim 5, further comprising supply means for providing pressurizing and preheating of said non-fuel fluid before it is injected into the combustion chamber.

9. The internal combustion engine of claim 8, further comprising a control system operatively coupled to the injector and the supply means for causing a first quantity of said non-fuel fluid having a first temperature to be injected during a first time interval within a compression stroke and a second quantity of said non-fuel fluid having a second temperature to be injected during a subsequent second time interval within an expansion stroke.

10. The internal combustion engine of claim 9, wherein said second temperature is at least 650 degrees Fahrenheit, and said first temperature is substantially less than said second temperature.

11. The internal combustion engine of claim 10, wherein said first time interval is prior to combustion and said second time interval is after commencement of expansion by a time factor of at least four.

12. An internal combustion engine having a plurality of cylinders each provided with water injector having a respective nozzle arrangement extending into a respective combustion chamber though which a controlled quantity of water is injected into the combustion chamber, comprising:
means for determining the temperature and combustion pressure of each combustion chamber;
means for determining the temperature, pressure and humidity of the atmosphere; and
a controller using the determined atmospheric temperature, pressure and humidity to control the quantity of water to be injected into the combustion chambers.

13. The internal combustion engine of claim 12 wherein the means for determining the engine chamber combustion pressure is capable of determining absolute ISO engine pressures.

14. The internal combustion engine of claim 12 further comprising means for determining the water content of the fuel, wherein the controller takes into account that water content when computing said quantity.

15. The internal combustion engine of claim 12 further comprising means for adjusting the amount of water added by the water injector so as to enable the engine to produce its rated capacity at ISO conditions, independent of atmospheric conditions.

16. The internal combustion engine of claim 12 further comprising an oil/water separator to remove water from the engine oil.

17. The internal combustion engine of claim 12 further comprising an exhaust heat exchanger to preheat at least some of the water being injected into the engine.

18. A method of operating an internal combustion engine of the spark ignition or compression ignition type having a plurality of combustion chambers though which a quantity of water or other non-fuel fluid is injected into the combustion chambers, comprising:
determining the temperature and combustion pressure of each engine chamber;
determining the temperature, pressure and humidity of the atmosphere; and
using the determined atmospheric temperature, pressure and humidity to control the water injected into the combustion chambers.

19. The method of claim 18 in which determining the engine chamber combustion pressure comprises measuring absolute ISO engine pressures.

20. The method of claim 18 further comprising determining the water content of the fuel used in the engine, and controlling the quantity of injected water quantity based upon the change in air density due to deviations in atmospheric conditions relative to ISO conditions, as well as the water content in the fuel.
